(19) United States
(12) Patent Application Publication
(10) Pub. No.: US 2008/0249437 A1
(43) Pub. Date: Oct. 9, 2008

(54) Therapeutic Device For Inducing Venous Blood Pressure Modulation

(75) Inventor: Edward H. Phillips, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: VBPM, Limited Liability Corporation (LLC), Troy, MI (US)

(21) Appl. No.: 11/961,305

(22) Filed: Dec. 20, 2007

Related U.S. Application Data
(63) Continuation-in-part of application No. 11/775,507, filed on Jul. 10, 2007.
Application No. 11/775,507 is a continuation-in-part of application No. 11/749,505, now abandoned.
(60) Provisional application No. 60/848,740, filed on Oct. 2, 2006.

(51) Int. Cl. A61H 99/00

(52) U.S. Cl. 601/26

(57) ABSTRACT

A therapeutic method and apparatus intended for enhancing blood circulation, and lymph and neural fluid flow throughout a person's body. The person is placed supinely in a comfortable and relaxed state on a support member, such as a bed which is operated by a controllable motor driven drive mechanism. The support member tilts cyclically like a seesaw to alternatively raise the person's upper torso and head about the lower extremities, and vice-versa.

### RELATED APPLICATIONS

The present application is related to U.S. patent application Ser. No. 11/209,813 filed on Aug. 16, 2005 and entitled “Rhythmic Blood Pressure Modulation and Legshaking Apparatus”, issued on Oct. 2, 2007 as U.S. Pat. No. 7,276,033, which patent (hereinafter the “'033 patent”) is expressly incorporated herein by reference. The present application is also a continuation-in-part of U.S. patent application Ser. No. 11/775,507 filed on Jul. 10, 2007 and entitled “Therapeutic Device for Inducing Blood Pressure Modulation”, which in turn was a continuation-in-part of U.S. patent application Ser. No. 11/749,505 filed on May 16, 2007 also entitled “Therapeutic Device for Inducing Blood Pressure Modulation” now abandoned; and claims priority of U.S. Provisional Patent Application Ser. No. 60/848,740 filed on Oct. 2, 2006 and also entitled “Therapeutic Device for Inducing Blood Pressure Modulation,” all of which are incorporated herein by reference.

### BACKGROUND OF THE INVENTION

The present invention relates generally to therapeutic devices and, more particularly, to a therapeutic device and a method of use therefor that is believed herein to enhance blood circulation as well as lymph and neural fluid flows throughout a person's body.

Various types of devices have been used for enhancing blood flow through selected portions of human cardiovascular systems. This has been done for the purpose of alleviating various symptoms associated with different types of diseases or conditions. For example, enhanced external counter-pulsation (hereinafter “EECP”) utilizes pressure cuffs around various portions of a person's lower extremities and buttocks. The pressure cuffs are sequentially and abruptly inflated and then deflated in sync with the person's heart rate such as to implement a reverse pulsation of blood flow back toward the person's upper torso and head immediately following systole. This results in pressure spikes of as much as 50 mmHg being imposed upon any partial arterial blockages that may be present in those portions of the person's body, and may in fact enable formation of collateral circulation passages around such partial blockages. In order to be effective, EECP is typically administered to a person over a series of 35 one-hour treatments during a seven-week period. During their abrupt inflation the pressure cuffs can often inflict significant discomfort in the person however, thereby causing him or her to be distressed and perhaps counteracting the therapeutic effect for which the device was intended. Furthermore, there has apparently been no suggestion that EECP is helpful in promoting enhancement of either lymph or neural fluid flows within the human body.

Another device was described in a book entitled “Surgical Nursing” by Eliason, Ferguson and Farrand and published as early as 1929 by the J.B. Lippincott Company. It was called a “Sander's oscillating bed for treatment of peripheral vascular disease”. In describing the Sander's oscillating bed and its use the authors stated the following:

“The Sander's oscillating bed is a method of administering passive exercises to allow intermittent filling and emptying of capillaries, venules and arterioles. The bed is set upon a rocker operated by a motor so that it tilts on its long axis at regular intervals. The intervals may be adjusted according to the needs of the patient and the wishes of the physician. This method of administering passive postural exercises may be carried out day and night and is claimed by some to have produced relief of the rest pain and of the pain associated with ulcers and gangrene. It may be used not only in arteriosclerosis and thrombo-angitis obliterans but also in minor degrees of arterial embolism.”

The Sander's oscillating bed was also described in the Aug. 4, 1951 issue of the Journal of the American Medical Association as being utilized at “high frequency” as a “vasoscillator”—thus implying that it was useful for dilating clogged blood vessels. It is believed herein that when it was utilized for this purpose, the Sander's oscillating bed was driven at a relatively high frequency significantly beyond 20 cycles/minute. On the other hand, other articles published during the 1950s detailed its use for augmenting ventilation in patients with poliomyelitis. This was obtained via internal manipulation of the patient's lungs obtained as a result of alternating gravitational forces cyclically displacing his or her intestines such as to cyclically elevate and depress the patient's diaphragm. In this case, the Sander's oscillating bed was driven at a “relatively low frequency” of perhaps 20 cycles/minute that was considered to be compatible with a normal rate of breathing.

As will be fully explained hereinbelow, it is believed herein that operation of such a bed at the high frequencies noted above would be grossly inappropriate. First of all, it would most likely induce discomfort in the patient. More significantly, there would most likely be insufficient time to substantially drain pooled venous blood from selected portions of a person's venous system during the portion of each cycle when they are subject to pressure values lower than atmospheric pressure, or later during the cycle, to totally fill the veins comprised in those portions of the person's venous system with new venous blood coming from associated arterioles, capillaries and venules—when otherwise those veins would have dilated and become subject to pressure values greater than atmospheric pressure. Thus, implementation of even the basic concept of venous blood pressure modulation as explained below would not be possible on a Sander's oscillating bed operated the high frequencies noted above. But as is also explained below and in some cases of perhaps even more significance, such high frequency operation would be totally incompatible with enhancing operation of a person's lymph system.

Further, it is also believed herein that all versions of the Sander's oscillating bed were implemented with a flat (e.g., planar) bed and, as implied above, “set upon a rocker operated by a motor so that it tilts on its long axis at regular intervals”. Because of such construction, it is also believed herein that shoulder and/or foot constraints were typically utilized for longitudinally restraining patients so that they wouldn't slide “up or down” excessively. It is believed herein that use of such artificial shoulder and foot constraints would also tend to induce discomfort in the patient. Perhaps because of the requirement for such artificial constraints, or because of the above explained high frequency misapplication in its use, or even simple patient discomfort associated with the high frequency operation, or because of safety concerns relating to the open rocker construction, the Sander's oscillating bed obviously fell out of favor.

An alternate type of therapeutic device that includes a bench or support member upon which a person can lie down is described in detail in U.S. Pat. No. 6,261,250. Harnesses are attached to each arm and leg of the person. The harnesses are attached to cables actuated by a gearmotor in a manner that cyclically and synchronously raises and lowers all of the person's limbs. The change in elevation of the person's limbs causes a moderate modulation of blood pressure in both of the arterial and venous networks of the person's cardiovascular system. Although it runs at a cyclic rate of slightly over 20 times/minute, this therapeutic device is none-the-less believed to be somewhat effective in enhancing blood flow throughout the person's circulatory system, including his or her coronary system as well as in his or her brain. In addition, it is also believed to be somewhat effective in enhancing neural fluid flow within the person's body generally, and particularly in the brain. However, it does require an amount of coordinated muscle activity on the person's part to properly position him- or her-self on the bench and to maintain his or her limbs within the harnesses, as well as to properly interact with the device. For some people, such interactions can be stressful and could even somewhat counteract the therapeutic effect for which the device is intended. Furthermore, the therapeutic device depicted in the '250 patent comprises an open counter-balanced flywheel that for safety reasons would obviously be of concern.

It is important to understand that utilization of any of these example therapeutic devices does not impose a medically oriented treatment upon a person similarly to that such as he or she would typically experience via utilizing invasive types of treatment provided by a medically licensed physician through his or her prescription of medication, or by execution of a surgical procedure. Rather, their use is generally non-invasive in nature, and with the exception of EECP, any person could use them in a self-operated manner at his or her own volition. Alternately of course, such self-operated apparatus could also be utilized with the assistance of an alternative medicine practitioner, or even at the suggestion of a medically licensed physician. Their use by any person can most accurately be described as that of non-invasively conditioning that person in a manner essentially similar to him or her exercising on exercise apparatus in a gym, so that his or her body could be enabled for improving, or even possibly for curing, itself.

It is believed herein that the human body is capable of achieving amazing self-curative powers. Thus it is also believed herein that an improved therapeutic device and an improved method are needed for enhancing blood, lymph and neural fluid flows throughout the human circulatory, lymph and nervous systems, as well as within the brain itself without inducing unacceptable levels of stress and/or discomfort.

### SUMMARY OF THE INVENTION

The present invention relates to an improved therapeutic method and self-operated apparatus intended for enhancing blood, lymph and neural fluid flows in a person's body and brain. The person places him or herself in a supine position on a support member, such as a bed or table formed in a contoured manner whereupon a person can comfortably lie without artificial constraints. The support member is then cyclically rocked or tilted in a seesaw manner so that the person is tilted from an upper torso and head-elevated position to a lower extremities-elevated position. Generally, it has been anecdotally observed that desired therapeutic blood, lymph and neural fluid flow enhancing effects are optimized when the person assumes a mentally relaxed state, and optimally so, when he or she is able to fall into a sleep state during operation of the apparatus. Further, because the person's dominant weight supporting points are continually moving between different areas of his or her buttocks and lower torso as a function of instant tilt angles obtained during the rocking motion, it has been anecdotally observed that the phenomenon of forming bed sores is highly unlikely or even impossible, irregardless of how long the person remains on the rocking apparatus.

A drive mechanism is used to cyclically move the support member in a seesaw manner in order to elevate the person's upper torso and head above his or her lower extremities, and then to elevate the person's lower extremities above his or her upper torso and head. The cyclical rate of motion can range between 2 to 10 cycles/minute and is preferably about 6 cycles/minute. The total angular range of motion of the support member relative to its nominally centered horizontal position can range between 10° and 60° and is preferably around 30°.

Again, it should be emphasized that utilization of the therapeutic method and self-operated apparatus does not impose a medically oriented treatment upon a person similarly to that such as he or she would typically experience via utilizing invasive types of treatment provided by a medically licensed physician through his or her prescription of medication, or by executing a surgical procedure. Rather, its use is generally non-invasive in nature and can be used by any person at his or her own volition. Alternately of course, it can be utilized with the assistance of an alternative medicine practitioner, or even at the suggestion of a medically licensed physician. In fact, its use by any person can more accurately be described as that of non-invasively conditioning that person via an internal massaging of his or her tissues through rhythmic compression and stretching of appropriate portions of his or her venous system, so that his or her body can be enabled for improving, or even possibly for curing, itself.

Other benefits, features and aspects of the present invention will become apparent from a review of the following description of preferred embodiments, when viewed in accordance with the attached drawings and appended claims.

### BRIEF DESCRIPTION OF THE DRAWINGS

FIG. 1 is a flow chart that illustrates an example method intended for enhancing blood, lymph and neural fluid flows in a human body and brain in accordance with the present invention.

FIGS. 2A, 2B and 2C are side views illustrating the range of motion of an example therapeutic device utilized for practicing the example method of FIG. 1.

FIG. 3 is a schematic view of a lymph collector.

FIGS. 4A and 4B are schematic views of a lymph pre-collector.

FIG. 5 is a side view depicting the example therapeutic device shown in FIGS. 2A, 2B and 2C in greater detail.

FIG. 6 is a flow chart that illustrates a method of controlling a therapeutic device comprising a servo drive mechanism but otherwise similar in function to that shown in FIG. 5.

FIG. 7 is a perspective view of an example drive mechanism for cyclically moving the therapeutic device shown in FIG. 5.

### DETAILED DESCRIPTION OF THE PREFERRED EMBODIMENTS

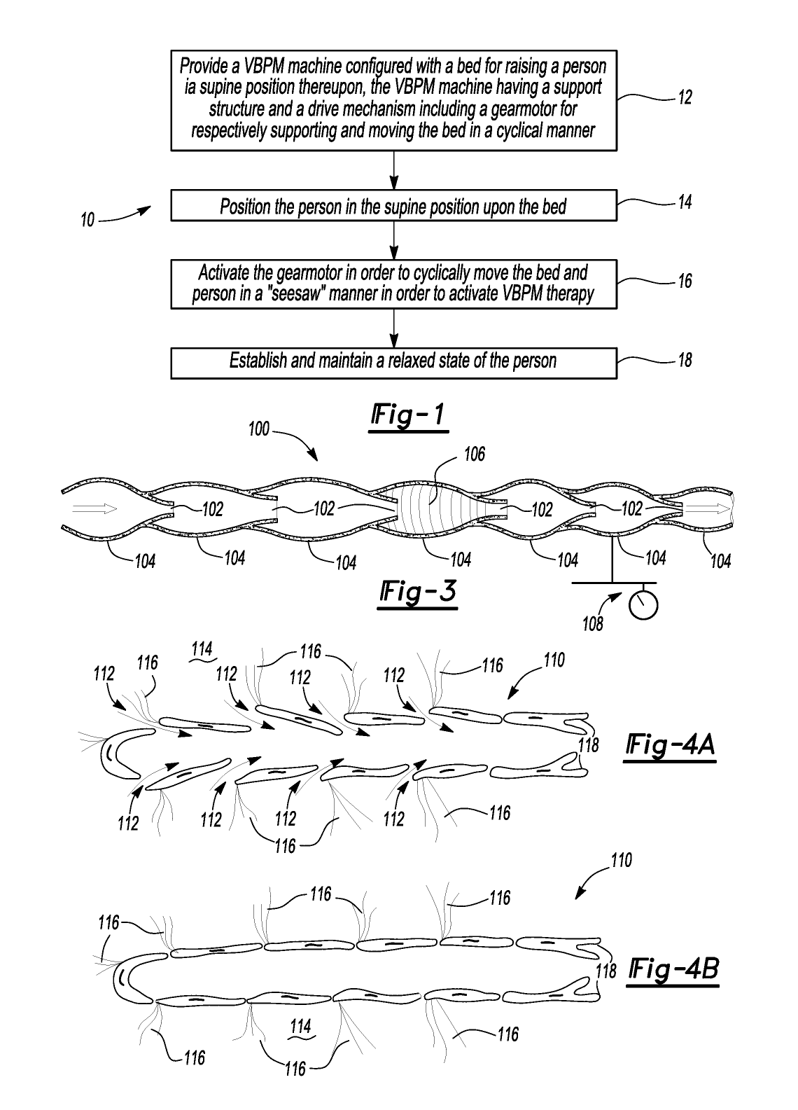

FIG. 1 is a flow chart that illustrates an improved example method 10 for inducing venous blood pressure modulation therapy (hereinafter “VBPM therapy”) on a venous blood pressure modulation machine (hereinafter “VBPM machine”), which VBPM therapy is believed herein to enable enhancement of fluid flows through the human circulatory, lymph and nervous systems, as well as within the brain itself. In some examples, the method 10 has been anecdotally observed to be therapeutically helpful for enabling an improved quality of life for persons having various types of physical and neural diseases or conditions such as heart or other forms of cardiovascular disease, Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

A first step 12 of the example method 10 includes providing a VBPM machine, which VBPM machine comprises a generally horizontal and preferably contoured support member (hereinafter referred to as a “bed”) configured for retaining a person generally in a supine position thereupon along a longitudinal axis such that his or her upper torso and head are longitudinally spaced apart from his or her lower extremities. The VBPM machine also comprises necessary support structure as well as a gearmotor and drive mechanism for pivotally supporting and moving the bed in a cyclical manner to be described in detail hereinbelow. A second step 14 includes positioning the person on the bed so that he or she lies supinely thereupon with his or her upper torso and head, and lower extremities spaced apart generally along the longitudinal axis.

A third step 16 includes activating the gearmotor for the purpose of cyclically moving or tilting the bed, and of course the person, in a “seesaw” manner in order to activate VBPM therapy. This causes the person's upper torso and head to be elevated above his or her lower extremities, and then the person's lower extremities to be elevated above his or her upper torso and head, and vice-versa. In one example, the cyclical rate of alternate elevation of the person's upper torso and head, and lower extremities (hereinafter “cyclical rate”) can range between 2 and 10 cycles/minute and is preferably about 6 cycles/minute while the total angular range of motion (hereinafter “angular range”) of the support member relative to its nominally centered horizontal position can range between 10° and 60° and is preferably around 30°.

As described in detail below, this procedure modulates blood pressure in both of the arterial and venous networks of the cardiovascular system. It is believed herein that resultant modulation of venous blood pressure within positive values thereof or even more dramatic switching of venous blood pressure between positive and negative values and back again with respect to atmospheric pressure (hereinafter “venous blood pressure modulation and switching events”, respectively) during each cycle of venous blood pressure modulation is principally responsible for enhancement of blood, lymph and neural fluid flows within the human body and brain, which enhancement of blood, lymph and neural fluid flows is believed herein to account for the above-mentioned anecdotally observed improved quality of life for persons having various types of physical and neural diseases or conditions such as heart or other forms of cardiovascular disease, Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

Utilizing lesser angular ranges than the preferred 30° would of course result in a reduced modulation of blood pressure. Although it is believed herein that this would also be effective in enhancing blood, lymph and neural fluid flows within the human body and brain, it might materially compromise the desired venous blood pressure modulation and/or switching event functions over significant portions of the body. Thus, achieving an equivalent improvement could require extended treatment times and/or an extended series of treatments.

On the other hand, utilizing greater angular ranges than the preferred 30° would result in increased modulation of blood pressure. But this might require the person to be strapped or “velcroed” to the bed in order to preclude him or her from sliding either upwards or downwards, and would almost certainty be required in cases wherein a selected angular range of motion resulted in the person's torso assuming even a relatively modest negative angular attitude whenever the bed approached its extreme lower extremities-elevated position. Furthermore, greater angular ranges might require the cyclical rate to be reduced in order to maintain a comfortable and relaxed state of the person. This of course would reduce the number of venous blood pressure modulation and/or switching events, and thus could even be counterproductive. In any case, it has been anecdotally observed that the preferred 30° angular range is quite sufficient for achieving desired therapeutic results.

The fourth step 18 of the example method 10 includes establishing and maintaining a comfortable and relaxed state of the person. In a preferred example, such a comfortable and relaxed state corresponds to establishing a sleep state of the person while he or she is experiencing VBPM therapy. In another example, the comfortable and relaxed state corresponds to a relatively low blood pressure state of the person, such as at or even below an “at rest” blood pressure determined according the person's age, weight, height, or other factors. In yet another example, the comfortable and relaxed state corresponds to the heart rate of the person, such as an “at rest” heart rate determined according the person's age, weight, height, or other factors. Factors involved in establishing and maintaining the comfortable and relaxed state of the person include: locating the VBPM machine in a relatively isolated and quite environment; avoiding any contact with the person (i.e., such as talking to him or her) during his or her treatment period with the purpose of inducing him or her to fall into a sleep state; and/or failing that, engaging in quiet and relaxing conversation with the person for the purpose of calming him or her if he or she exhibits hyperactivity, hypersensitivity or hyperirritability symptoms.

Properly selecting angular range and cyclical rate values is also important in establishing and maintaining the comfortable and relaxed state of the person. The combination of angular range and cyclical rate is chosen such as to preclude dizziness or other discomforts in the person and is a definite factor in inducing a comfortable and relaxed state conducive to the person attaining a state of sleep. In general, it has been found through anecdotal observation that the combination of angular range and cyclical rate should be chosen such that their product is between 90 degree-cycles/minute and 270 degree-cycles/minute. Consistently, the preferred combination of an angular range of 30° and a cyclical rate of about 6 cycles/minute results in their product being 180 degree-cycles/minute, which values have been anecdotally observed to provide the above noted improvements in quality of life without inducing discomfort. Other combinations chosen from within the above mentioned angular ranges of 10° and 60°, and cyclical rates between 2 to 10 cycles/minute could certainly be acceptable for therapeutic use however.

Because a person's dominant weight supporting points are continually moving between different areas of his or her buttocks and lower torso as a function of instant tilt angles obtained during the rocking motion of a VBPM machine, it has also been anecdotally observed that the phenomenon of forming bedsores is highly unlikely or even impossible, irregardless of how long the person remains on the rocking apparatus. This suggests a totally different preferred utilization method for a VBPM machine wherein its use by a bedridden patient would avoid formation of bedsores. This use could of course be non-therapeutic. Thus very low cyclical rates could be utilized—perhaps even lower than the above stated range of 2 to 10 cycles/minute with a preferred method including the steps of providing a VBPM machine enabled for cyclic operation at a very low cyclic rate; placing a bedridden person on the bed of the VBPM machine; and activating it for cyclic motion.

Prior to beginning any treatment using the present invention, a preliminary workup comprising noting a person's vital statistics and perhaps performing any pertinent neurological testing could be done in order to establish a baseline status for that person as of the start of that particular treatment session. One might note a person's age, blood pressure, heart or neurological disease history or conduct and record any appropriate blood count, neuropathy or other tests should that person be diabetic for instance. In addition, special precautions should be taken in the case of a brain injured person or perhaps for one having Alzheimer's disease. Further, it would be desirable to do a comparative post treatment workup as well in order to record any changes related to the person having experienced VBPM therapy during that session. And still further, it would be desirable to compile each person's workup documentation in order to establish that person's progress over time.

The cardio-pulmonary portion of the human circulatory system includes the right side of the heart receiving oxygen-depleted blood from a person's venous system and pumping it through the lungs wherein carbon dioxide is exchanged for oxygen, and then on to the left side of the heart from where the now oxygen-rich blood is pumped into the arterial network. The arterial network comprises arteries and arterioles that convey the oxygen-rich blood from the heart to an extraordinary multitude of capillaries. The arteries include a layer of smooth spirally oriented muscle cells that serve to maintain arterial blood pressure between systolic events. Similar layers of smooth spirally oriented muscle cells are also comprised in the arterioles and are utilized by the person's brain for selectively controlling their size. In addition, each capillary is protected by a pre-capillary sphincters which sphincters are utilized by the person's brain for selectively controlling proportions of capillaries open to blood flow in any portion the person's body. These factors permit the person's brain to regulate blood flow throughout his or her cardiovascular system in addition to controlling instant blood pressure values and selectively servicing trauma of any type including minor trauma such as a cut or scrape. As will be discussed in greater detail below, blood flows through the so selected ones of the capillaries, wherefrom oxygen is exchanged for carbon dioxide via moderately pressurized oxygen bearing plasma flowing into surrounding interstitial space through tiny pores in the arteriole/sphincter ends of the capillary walls—and then carbon dioxide bearing plasma flowing back into the capillaries via osmosis through more tiny pores in the downstream or venule ends of the capillary walls, and then through the venules themselves and on to the greater venous system.

The greater venous system includes veins that convey the now oxygen-depleted blood from the venules back ultimately to the vena cavas (e.g., the two large veins that return venous blood to the right atrium of the heart) and therethrough to the right side of the heart. The larger veins periodically comprise semi-lunar folds that act like one-way check valves that serve to preclude reverse flow back toward the venules and capillaries. Generally the veins and venules of the venous network are simpler and more compliant than the arteries and arterioles. However, they also include layers of smooth spirally oriented muscle cells. These layers of smooth spirally oriented muscle cells in the veins are utilized by the person's cardiovascular control center for regulating their circumferential size. This involves the person's brain and body continuously executing a very complex and precise servo control of the volumetric size of the venous system as a whole. This complex function is implemented in accordance with a fairly long time constant—lasting perhaps tens of seconds and definitely longer than a single cycle of operation of the VBPM machine. In any case, the veins act as an active blood reservoir that contains about 65% of the body's total blood volume. The size of the veins and thus the volume of the reservoir is controlled in response to signals emanating from a cardiopulmonary mechanoreceptor located in the right atrium of the heart such that average venous blood pressure thereat is maintained very slightly above atmospheric pressure and thus at atmospheric pressure at a horizontal plane a few inches thereabove (hereinafter the “zero pressure plane”).

As a result, venous blood pressure present at any particular point within a person's venous system can be determined by the formula

P=1.875h

where P is the difference between venous blood pressure at that particular point and atmospheric pressure (in mmHg), and h is the vertical distance between that particular point and the vertical position of his or her zero pressure plane (in inches). Thus, portions of the venous system that are instantly positioned vertically below the zero pressure plane have positive pressure (e.g., relative to atmospheric or zero pressure) whereby there is a positive differential pressure value imposed between them and the outside of the person's body. On the other hand, portions of the venous system that are instantly positioned vertically above the zero pressure plane have negative pressure whereby there is a negative differential pressure value imposed between those portions of the venous system and the outside of the person's body. This compresses those veins and causes previously “pooled” venous blood contained therein to “drain” back toward the vena cavas (e.g., with the venous blood freely moving through the above described check valves) with the result that those veins are compressed or even somewhat flattened out.

Then later in the cyclic motion, when those portions of the venous system are again positioned below the zero pressure plane, they fill with oxygen depleted blood flowing from juxtaposed capillaries and venules (e.g., not back down through the larger veins themselves because of the one-way flow nature of the valves) and expand. In either of these cases, it is believed herein that it is necessary to provide adequate time for allowing these “draining and filling” functions to substantially occur. Thus the relatively slow preferred cyclic rate of operation of about 6 cycles/minute is herein deemed to be appropriate for this reason alone.

It is believed herein that cyclic operation of a VBPM machine causes connective tissue located between even small branches of a person's venous system undergoing such vertical position transitions below, or more dramatically, above and then below that person's cyclically moving zero pressure plane to be continually compressed and then relaxed or even stretched. Thus, in a manner more thoroughly explained below, it is further hypothesized that, as a result, any juxtaposed arterial, lymph or neural flow channels are continually compressed and stretched as well. Thus, the fundamental concept of VBPM therapy is to continually compress and then stretch any such flow channels that may be dysfunctional in any way (i.e., such as by being blocked) until they are restored to a more natural and functional state.

This general principle can be demonstrated by observing what happens to a visible peripheral vein running along the back of one's hand and arm as that hand and arm are slowly raised toward shoulder height. Portions of that vein will soften and contract, and even begin to flatten out as they reach a few inches below shoulder height and then remain flattened while they are above that height. In fact, as one slowly raises the hand and arm he or she may even feel the progression of this flattening as different portions of the vein suffer a transition from positive to negative pressure. It is believed herein that substantially the same action occurs within the fine venous structures comprised in the upper torso and head, and also within the lower extremities of a person whenever he or she is supinely disposed upon a cyclically moving VBPM machine. And as is explained below, it is further believed that this cyclically varying venous pressure causes a concomitant modulation of interstitial fluid volute and pressure as well.

Such variations of venous blood pressure are illustrated in FIGS. 2A, 2B and 2C for a person 30 disposed on an example VBPM machine 20. FIG. 2A depicts the portion of its cycle of operation whereat the person 30's upper torso 22 and head 24 are elevated; FIG. 2B depicts the portions of the cycle whereat the person 30 is disposed in a nominally centered horizontal position (hereinafter “horizontal position”); and FIG. 2C depicts the portion of the cycle whereat the person 30's lower extremities 26 are elevated. Of these, the horizontal position depicted in FIG. 2B can logically be said to approximate the average disposition of the person 30 when he or she is disposed upon the cyclically moving VBPM machine 20. Thus in the horizontal position, the instantaneous location of the zero pressure plane 32 can be approximated by a zero pressure line 34b passing through the upper torso 22 whereby portions of the venous system above and below the zero pressure line 34b are respectively subject to negative and positive pressure values. Zero pressure lines 34a and 34c respectively depicted in FIGS. 2A and 2C similarly define instantaneous locations of the zero pressure plane 32. Thus the person 30's upper torso 22 and head 24 are subject to alternating negative and then positive pressure values, even as his or her lower extremities 26 are concomitantly subject to alternating positive and then negative pressure values. Again, this occurs as a result of the above noted inability of the venous volumetric control system to quickly respond within the preferred six cycle/minute operational frequency.

Assuming that a combination comprising the preferred angular range and cyclical rate values of about 30° and 6 cycles/minute is chosen, gravitational forces resulting from alternating cyclical elevation of the person 30's upper torso 22 and head 24, and then lower extremities 26 rhythmically modulate the venous blood pressure in the upper torso 22 and head 24, and also of course the lower extremities 26, over a range of perhaps 20-30 mmHg. Thus, when the upper torso 22 and head 24, and alternately the lower extremities 26, attain peak elevation above the zero pressure line 34 as respectively depicted in FIGS. 2A and 2C, venous blood pressure in those portions of the person 30's body is lowered below atmospheric pressure by up to 15 mmHg. Because the arterial blood pressure in those portions of the person 30's body is nominally lowered by the same amount, the pressure drop across the comprised arterioles, capillaries and venules substantially remains the same. Thus the returning blood flow approximately remains the same. But there is now a pressure differential of as much as 15 mmHg between atmospheric pressure externally impressed upon the person 30's body and the venous blood pressure within those portions of the his or her body. As explained above, this pressure imbalance enables the surrounding tissue to somewhat compress or shrink those portions of the venous system and forces venous blood to flow from those veins generally toward the vena cavas (again, this phenomenon is responsible for the observed flattening of peripheral veins in a person's hand and forearm as he or she raises that arm as well as the general feeling that blood is “draining” down from that arm as and after it is elevated).

On the other hand, as the upper torso 22 and head 24, or alternately, the lower extremities 26 are lowered as respectively depicted in FIGS. 2C and 2A, pressure values in the venous blood in those portions of the person 30's body rise from a negatively valued pressure to a positively valued pressure of perhaps up to 10 mmHg in the head and 20 mmHg in the lower extremities as they “fill up” with new venous blood issuing from their associated artery and arteriole fed capillaries and venules. Even the venous blood pressure in the remaining portions of the person 30's body is subject to positively valued modulation as new venous blood enters the comprised veins. Thus, positive differential pressure differences occur between localized venous blood pressures and atmospheric pressure. This causes the veins to swell because the returning blood from arterioles, capillaries and venules tends to “pool” under the influence of ever-higher pressure and expands the smooth spirally oriented muscle tissue of the veins.

But in addition to venous blood pressure cyclically varying in the manner described above, venule pressure is modulated in a cyclically varying manner as well. This of course results in a cyclic modulation of the above noted osmotically driven flow of carbon dioxide bearing plasma back into the capillaries through the tiny pores in the downstream or venule ends of the capillary walls. This in turn results in a concomitant in phase modulation in interstitial fluid volume and therefore pressure. And that in turn amplifies the above noted compression and stretching of juxtaposed arterial, lymph or neural flow channels in accordance with a more completely described theory of the basic operational mechanism behind VBPM Therapy.

In any case, it is believed herein that the modulation and/or switching polarity of venous blood pressure and concomitant in phase modulation in interstitial fluid volume result in sequentially varying three-dimensional pressure gradients being formed within the tissue of the person 30's body. As explained above, it is believed herein that this results in a cyclical continual compression and stretching hereinafter referred to as “massaging”) of the tissue and fine arterial, lymph and neural fluid flow channels. This may, for instance, result in breaking through or overcoming various forms of blockages in the cardiovascular, neural and lymph systems, or in breaking down plaque deposits in the manner suggested below, or even in straightening out flattened and twisted fluid flow channels (e.g., commonly associated with Alzheimer's and perhaps various other neural diseases).

In particular, such massaging of the various flow channels associated with the brain is believed herein to enable opening of neural fluid flow channels and enhancing blood flow in and to the brain. In one example case study for instance, before and after sets of brain scans as well as anecdotal observations demonstrated that utilization of VBPM therapy had resulted in a significant increase of blood flow and density as well as brain function activity in the brain of a traumatically brain injured person.

In addition to the above described possible opening up of fine arteries, arterioles, capillaries, venules, and lymph and neural flow channels, it is believed herein that similarly induced internal massaging of tissue juxtaposed to partially blocked portions of coronary arteries may induce related capillaries to extend, link up and form collateral profusion flow channels or passages around partially blocked portions of the coronary arteries. This is thought to be the primary operative mechanism behind anecdotally observed alleviation of angina symptoms achieved through utilization of VBPM therapy by persons suffering from heart disease.

It is further believed herein that the messaging of tissue surrounding cyclically compression and stretching veins can also physically manipulate metallic and organically based plaque deposits and/or floating plaque particles present within arteries in such a manner as to encourage the plaque deposits and/or floating particles to break down into smaller and smaller particles. Then, and especially in conjunction with the use of chelator and bile enhancing supplements, it is believed that the plaque particles progressively dissolve, or at least disintegrate into micro-particles small enough to pass through the capillaries and into the venules and veins, and eventually on to the person's liver and/or kidneys where they can be eliminated naturally. This is thought to be the primary operative mechanism behind an apparent “cleansing function” whereby metallic and organically based plaques in the circulatory system have been observed to be progressively eliminated over a succession of one or more treatment sessions and thus alleviate symptoms associated with the plaque deposits such as those that are common to peripheral artery disease or heart disease.

The extent of similar action on any plaque deposits trapped between tunica intima and tunica media tissue layers of the juxtaposed arteries is not known at this time. However, in another example case study involving a sequence of four instances wherein trapped plaque deposits ruptured through the tunica intima layers of a person's coronary arteries, it has been anecdotally observed that the above described internal messaging of surrounding tissue can provide adequate blood flow for supporting heart function without an infarction occurring. In each of these anecdotally observed events, chelator and bile enhancing supplements were utilized to attack the plaque and clot formations resulting therefrom, with the clearing process typically taking about four days.

As mentioned above, oxygen is exchanged for carbon dioxide via plasma flowing between capillaries and surrounding interstitial space and back again through tiny pores in the capillary walls. In addition, pressure present within the arteriole/sphincter ends of the capillaries is sufficient to additionally drive sugars, protein, fat and doubtless other material into the surrounding interstitial space through the first encountered tiny pores. Inclusion of these materials serves to more completely describe interstitial fluid that enables nutrient delivery and waste removal etc. as well as the above noted oxygen/carbon dioxide exchange. As noted above, lower fluid pressure normally present in the venule ends of the capillaries normally allows osmotic pressure to drive most of the interstitial fluid back into those capillaries. However, the remaining excess interstitial fluid (i.e., excess protein, fat and other waste material) is normally removed by a person's lymph system.

As described in detail in a book entitled “Silent Waves, Theory and Practice of Lymph Drainage Therapy” by Bruno Chickly, M.D., D.O. (hon) and published by International Health & Healing Inc. Publishing of Scottsdale, Ariz., the lymph system is a secondary circulatory system that normally implements a one-way flow of the excess protein, fat and other waste bearing material (i.e., as lymph fluid) from interstitial space (e.g., from everywhere in the body) generally upwards through various lymph flow channels (i.e., as described in more detail below) toward a person's right lymphatic and thoracic ducts (not shown). These ducts then drain the lymph fluid into the circulatory system at the right and left subclavian veins, and then sequentially from the vena cava though the right side of the heart, the lungs, the left side of the heart, and finally, to the liver and or kidneys for processing and proper elimination.

As depicted schematically in FIG. 3, one-way flows of lymph fluids within the lymph system generally pass through a multitude of lymph collectors 100 each comprising closely spaced sequential one-way valves 102 (i.e., similar to those found in veins) interconnected by very short segments of lymphatic vessels 104 called lymphangions. The lymphangions 104 are only about 6 to 20 mm long (i.e., as described in “The Genetic History of the Valves in the Lymphatic System of Man”, by O. F. Kampmeir, Am. J. Anat. 1928, 40:413-457). They comprise spiral muscle layers 106 that contract involuntarily in response to innervation signals issuing from the person's autonomic nervous system as indicated schematically at numeric indicator 108. When a person is at rest, the rate of such contractions normally occurs at only about 5 to 8 cycles/minute (i.e., as described in “Intrinsic Contractility of Leg Lymphatics in Man: Preliminary Communication”, by W. L. Olszewski et. al., Lymphol, 1979, 12: 81-84: and “Intrinsic Contractility of Prenodal Lymph Vessels and Lymph Flow in Human Leg” by W. L. Olszewski et. al., Am. J. Physiol, 1980, 239:775-783). In so doing, the combinations of sequential one-way valves 102, lymphangions 104, and spiral muscle layers 106 act as pumping mechanisms that serve to force the lymph fluid along through the valves 102 and on to the right lymphatic and thoracic ducts—thus moving the one-way flow of excess protein, fat and other waste bearing lymph fluid upwards through the person's lymphatic flow channels and eventually on to the right and left subclavian veins as described above.

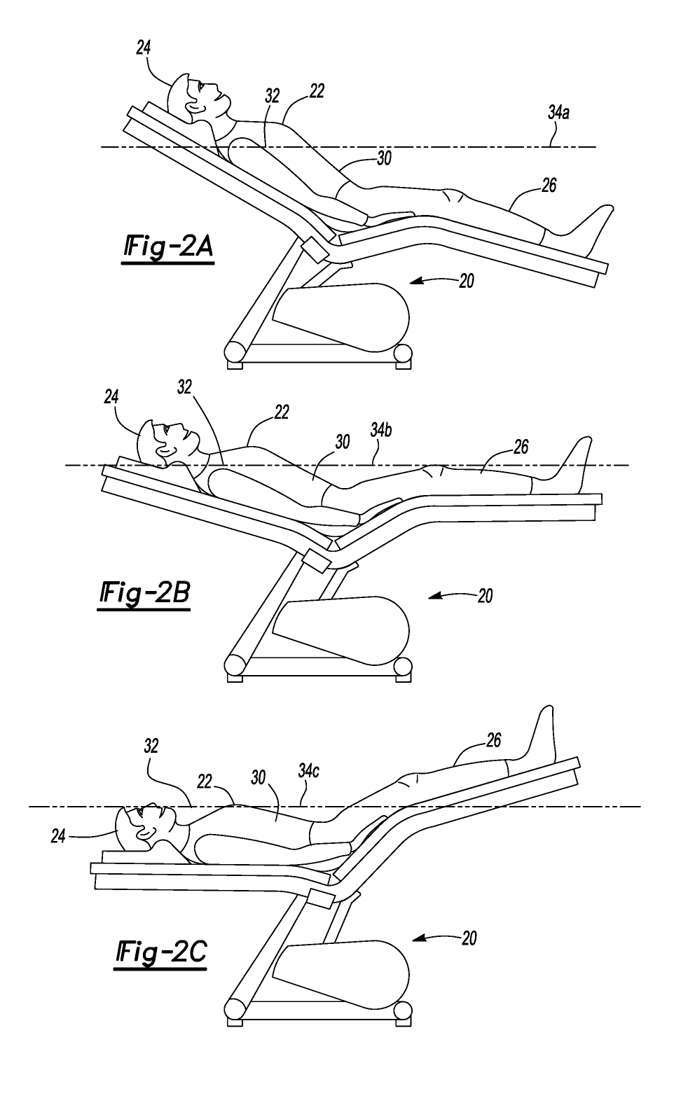

As depicted schematically in FIGS. 4A and 4B, excess interstitial fluid first becomes lymph fluid by entering minute lymph capillaries (not shown) formed like cul-de-sacs and located in extra cellular spaces surrounding each one of all enormous multitude of lymph pre-collectors 110. As shown in FIG. 4A, the lymph fluid next enters the lymph pre-collectors 110 through open junction ends 112 whenever the fluid pressure in the pre-collectors 110 is less than that present in the minute lymph capillaries, and of course, juxtaposed interstitial space 114. Anchoring filaments 116 help to open the junction ends 112 widely whenever that differential fluid pressure becomes significant. On the other hand, whenever that differential fluid pressure inverts, the junction ends 112 immediately close, as shown in FIG. 4B, in order to prevent back flow of lymph fluid into the minute lymph capillaries. The lymph fluid next enters juxtaposed lymphangions 104 (not shown in FIGS. 4A and 4B) via lymphatic bicuspid valves 118. On the other hand, the lymphatic bicuspid valves 118 are closed by inverse differential fluid pressure whenever higher pressure is present in the juxtaposed lymphangions 104 (i.e., should such occur during the period when the lymphangions 104 are contracting) in order to preclude lymph fluid back flow into the lymph pre-collectors 110.

Should any veins be subject to increased pressure values (i.e., such those in one's feet while on a long airplane trip) the normal osmotic flow of interstitial fluid back into juxtaposed capillaries will of course be somewhat impeded. This will tend to increase interstitial space pressure that in turn, will attempt to promote increased lymph fluid flow into the lymph capillaries and lymph pre-collectors 110. However, because of a concomitant increase of lymph system backpressure that is also due to gravity effects, the normal upward one-way flow of lymph fluid will also be impeded. As a result, lymph fluid will in tend to back up resulting in an increase of interstitial fluid trapped in the interstitial space 114. This phenomena coupled with some swelling of the veins themselves is responsible for the feet swelling during prolonged airplane trips.

Generally, lymph fluid movement occurs slowly and sometimes problematically at rates of up to only about 4 liters/day with nominal driving pressures of only 1 to 2 mmHg provided by smooth spirally oriented muscle cells of each lymphangion. Blockages can, and do, occur—often as a result of trauma or surgery. Such blockages can cause abnormally high intralymphatic pressures and excessively dilated lymphangions 104, which in turn result in juxtaposed ones of the valves 102 becoming incompetent. This allows lymph fluid to flow backwards, and in turn, causes more peripheral lymphangions 104 to excessively dilate with more valves 102 then becoming incompetent. This incompetency is then transmitted back to the lymphatic bicuspid valves 118 and then the junction ends 112, with lymph fluid then flowing back into the interstitial spaces 114, thus resulting in lymph fluid accumulation in interstitial spaces 114. The end result is lymphedema with abnormal tissue swelling. Diabetic individuals are especially subject to having such blockages in their lymphatic systems and often suffer from lymphedema with abnormal tissue swelling.

With reference to utilization of VBPM therapy on a VBPM machine 20, it is interesting to note that its preferred operational frequency of about 6 cycles/minute falls within the above noted typical resting lymphangion spiral muscle contraction rate of 5 to 8 cycles/minute. It is hypothesized herein that the calming action of VBPM therapy typically causes a person's parasympathetic nervous system to become dominant over his or her sympathetic nervous system and slow his or her lymphangion spiral muscle contraction rate, and further, that this may be a contributing factor in inducing that person to fall into a state of sleep on the VBPM machine 20. Especially in conjunction with that, it is further believed herein that after perhaps ten to twenty minutes of being on the VBPM machine 20, a person's lymphangion spiral muscle contraction rate slows to a synchronously matching (e.g., with the VBPM machine 20) contraction rate of approximately 6 cycles/minute and “locks” thereto in an appropriately phase locked manner.

As a result, it is hypothesized that when the lower extremities are lowered and those interstitial spaces are subject to positive pressure, entry of interstitial fluid into the lymph capillaries, lymph pre-collectors 110 and juxtaposed lymphangions 104 is maximized—thereby increasing incoming lymph flow. Then later during the machine cycle when the lower extremities are elevated, a more efficient upward one-way flow of lymph fluid occurs through the lymphangions 104 because the force of gravity then assists lymphangion spiral muscle layer contraction in driving the lymph fluid upward. Finally then, a completely described theory of the operational mechanism behind VBPM Therapy can be obtained through adding this hypothesized explanation relating to improved lymph system function to those relating to the continual compression and stretching of arterial, lymph and neural flow channels.

The improvement in lymph system function has been anecdotally observed in still other case studies wherein relatively rapid reversal of lymphedema with abnormal tissue swelling has been observed in conjunction with utilizing VBPM therapy. This is believed to have occurred in part as a result of the above-described cyclic tissue compression and relaxation clearing the effected person's problematic lymphatic flow channel blockages—and also in part as a result of an increased flow of lymph fluid implemented by that person's lymphangion spiral muscle rate locking on to the approximately 6 cycles/minute cyclic operational frequency in the also above-described appropriately phase locked manner. Thus, it is believed herein that lymph circulation is enhanced via utilization of VBPM therapy.

It has also been anecdotally found that blood glucose levels are generally reduced in persons utilizing VBPM therapy. It is believed herein that this phenomenon is can also be explained by the above-described enhancement of lymph circulation. In this case, it is hypothesized that it provides a supplemental path for disposing of excess sugar in the interstitial spaces 114 in addition to returning it osmotically to the venous ends of the capillaries. It is believed that this reduces the concentration of sugar in both the interstitial spaces 114 and the greater venous system. In any case, the reduction of blood glucose levels is quite beneficial for persons having diabetes, and has typically occurred in persons having either Type 2 diabetes or Type 2 diabetes with insulin. On the other hand, it can lead to a non-diabetic person achieving too low a sugar level. It has been found that if one is subject to this type of condition however, he or she can usually avoid it by consuming a glass of fruit juice prior to using VBPM therapy.

Approximately 70,000 diabetic persons stiffer lower extremity amputations every year as a result of having supposedly irreversible neuropathy or incurable wounds (i.e., that turn gangrenous) as well as the above noted lower limb lymphedema with abnormal tissue swelling. In addition to reversing the lymphedema with abnormal tissue swelling in the manner described hereinabove, VBPM therapy has also been anecdotally found to reverse such supposedly irreversible neuropathy and achieve therapeutic closure of such supposedly incurable wounds. It is hypothesized that these results are yet other manifestations of the above-described manner in which VBPM Therapy typically clears blockages in fluid flow channels.

It is not believed herein that VBPM therapy has the capability of “regenerating” nerves. None-the-less, other case studies have served to anecdotally demonstrate reduction of nerve related disorders such as indicated by significantly reduced symptoms of persons having Parkinson's disease. In accordance with the latest theories relating to the cause of Parkinson's disease such as by toxic “clumping” destruction of substantia nigra (SN) neurons (i.e., as shown in “Aggregation of alpha-synuclein by DOPAL, the monoamine osidase metabolite of dopamine”, by William J. Burke et. al. and published on line in Acta Neuropathologica copyright Springer-Verlag 2007), it is believed herein that the above described manipulation of related neural flow channels tends to break down the “clumping” action and thereby restore still surviving SN neurons to proper functionality. Consistent with that: “early onset” Parkinson's subjects have had the greatest success with VBPM.

A reduction of medication dosages, or in some cases even total their elimination, has been a further benefit for many persons utilizing VBPM therapy. By way of example, many persons having Type 2 diabetes with insulin have had to reduce or even eliminate their usage of insulin in order to avoid becoming hypoglycemic because of the above noted reduction of blood glucose. In another example, persons having Parkinson's disease have typically had to reduce their normally prescribed medication dosages in order to avoid overdose symptoms (i.e., such as uncontrolled and wildly gyrating arm and leg motions). It is hypothesized that such reductions of medication dosages have come about because of increased blood circulation or elimination of the above described “clumping” action resulting from using VBPM therapy. Therefore, an additional benefit of using VBPM therapy in accordance with the example method 10 may be that medication dosages can be reduced, or in some cases even eliminated.

It is believed that the phenomenon of drug addiction involves interaction with dopamine generated within the brain. Because of this as well as the calming influence of VBPM therapy, it is hypothesized that utilization of VBPM therapy may be helpful in rehabilitation treatment for various forms of drug addiction.

It is further believed herein that the above-described working of tissue constitutes an internally generated form of exercise that consumes and converts chemical energy derived from nutrients present in the blood into heat on a micro level thereby increasing metabolism. A person can readily demonstrate this concept as follows:

While leaving one hand immobile, that person cyclically elevates and then lowers the other at a rate of about 6 cycles/minute for a couple of minutes. If the palms of both hands are than put on the cheeks he or she will find that the one that was elevated and lowered is considerably warmer than the one that was left immobile—even though it had been gorged with venous blood. Further, he or she will likely experience a significant tingling sensation in the elevated and lowered hand.

Again with reference to optimum utilization of VBPM therapy as described in the fourth step of example method 10, it is believed that establishing the comfortable and relaxed state of the person enhances all of the operative mechanisms described above. Otherwise whenever one is under stress from discomfort or even when actively engaged in conversation, the desired interaction between a person's sympathetic and parasympathetic nervous systems leading to the synchronous phase locking of the lymph system described above might be disturbed and preclude the person form falling into the desired sleep state. Further, the smooth spirally oriented muscle cells associated with the veins and venules could even tend to activate and thus resist the desired swelling and collapsing action.

The observed fact however, is that most persons do typically fall into a sleep state when they are subject to the gentle rocking motion of a VBPM machine. This suggests that VBPM therapy could be useful therapeutically for inducing many persons suffering from sleep disorders to fall into a state of sleep when they experience insomnia. This of course typically involves utilization of the VBPM machine for extended time periods typically lasting well beyond an hour in length, and as described above, may require them to first consume a glass of fruit juice prior to getting on the VBPM machine.

But additionally, it has been observed that many persons tend to loose weight when so utilizing a VBPM machine for extended periods without having made any other change in lifestyle or eating habits. It is believed that this can be accounted for by the above described concomitantly occurring VBPM therapy caused enhancement of lymph system function and internally generated form of exercise that consumes and converts chemical energy derived from nutrients present in the blood into heat on a micro level thereby increasing metabolism.

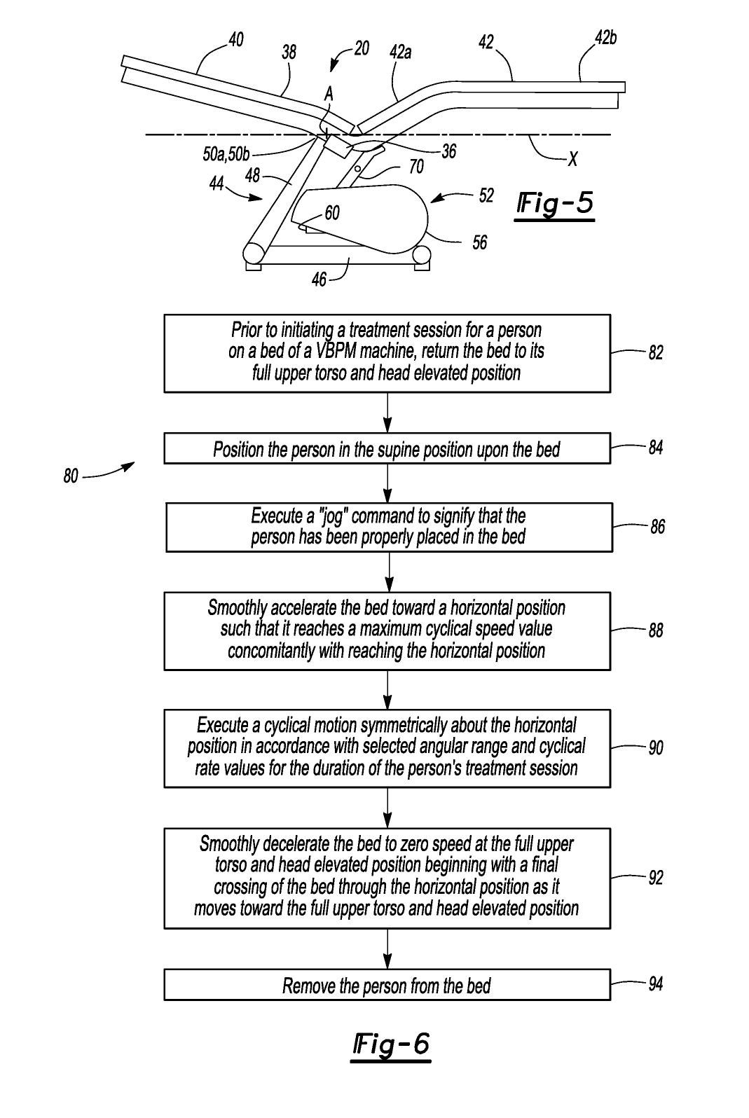

FIG. 5 is a side view of an example VBPM machine 20 useful for implementing the example method 10. In this example, the VBPM machine 20 includes a bed 38 here shown in the horizontal position. The bed 38 is configured with a torso and head-supporting portion 40, and a lower extremity-supporting portion 42 spaced generally along a horizontally disposed longitudinal axis “X”. The lower extremity-supporting portion 42 is in turn configured with a thigh-supporting portion 42a and a calf and foot-supporting portion 42b. The torso and head-supporting portion 40 is preferably angled upwards with reference to the horizontally disposed longitudinal axis “X” at an angle approximately equal to half of the selected angular range while the thigh-supporting portion 42a is preferably oppositely angled upwards at an angle approximately equal to the selected angular range, and the calf and foot-supporting portion 42b is preferably disposed in a plane nominally parallel to the longitudinal axis “X”.

The bed 38 is pivotally mounted to a supporting frame 44. The frame 44 includes a base section 46 that supports all angled section 48. In this example, the angled section 48 includes pivots 50a and 50b that pivotally connect to a portion of the bed 38 (FIG. 7). The pivots 50a and 50b define a pivot axis “A” that is oriented in a transverse manner with respect to a vertical plane (not shown) that comprises the longitudinal axis “X”. Finally, a drive mechanism 52 is utilized for rotatably moving the bed 38 in a cyclical manner about the pivot axis “A” in accordance with selected angular range and cyclical rate values, whereby the longitudinal axis X is then operative for defining instant rotational orientations of the bed 38 around the pivot axis A (i.e., between the extreme positions depicted in FIGS. 2A and 2C).

The incorporated '033 patent depicts a Scotch yoke drive assembly 96, a crank and connecting rod mechanism 188, a servo controlled rack and pinion gear set 194, and a servo controlled hydraulic drive 196, any of which would be suitable for cyclically moving the bed 38. Because descriptive presentations of the Scotch yoke drive assembly 96, the servo controlled rack and pinion gear set 194, and the servo controlled hydraulic drive 196 have been made in the incorporated '033 patent, no further description relating to any of these types of drive mechanisms is required herein. On the other hand, the preferred example VBPM machine 20 of the present invention utilizes a simplified example crank and connecting rod mechanism 54. Thus, its construction and operation is described hereinbelow with reference to FIG. 7.

Either of the Scotch yoke drive assembly 96 shown in FIGS. 8A-C of the incorporated '033 patent, crank and connecting rod mechanism 188 shown in FIGS. 9 and 11 of the incorporated '033 patent, or the example crank and connecting rod mechanism 54 utilized in the present invention can be controlled by a simple switch such as switch 36 depicted in FIG. 5 of the present application. In the case of the incorporated '033 patent such a switch would be operative to activate and deactivate a gearmotor 98 depicted in each of FIGS. 8A-C, 9 and 11 thereof. On the other hand, either of the servo controlled rack and pinion gear set 194, or the servo controlled hydraulic drive 196 (i.e., comprising a servomotor driven pump and a hydraulic cylinder), respectively shown in FIGS. 12 and 13 of the incorporated '033 patent, could be utilized for achieving selected combinations of angular motion and cyclical rate as deemed suitable for individual persons. In either case, a controller 130 also shown and described in the incorporated '033 patent could be used for commanding appropriately selected angular range and cyclical rate values, or even for programming varying values of angular ranges and cyclical rates during treatment sessions.

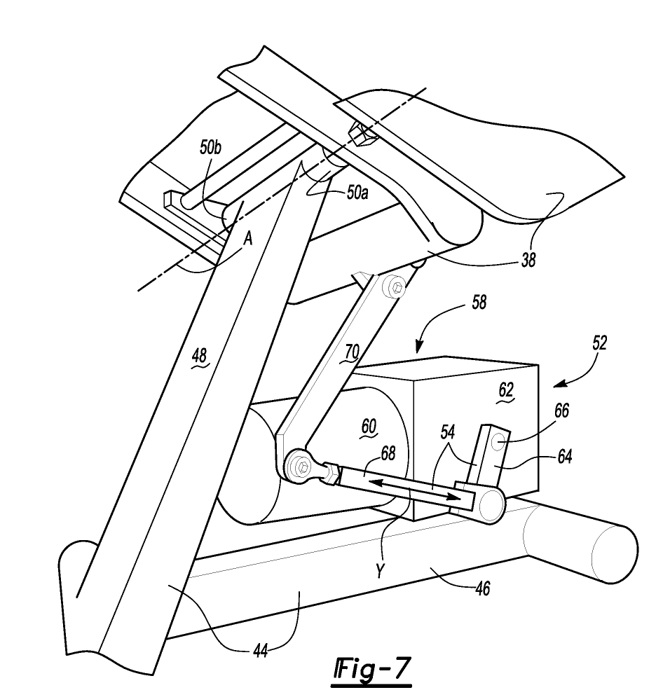

FIG. 6 of the present application illustrates an example method 80 for optimally controlling a VBPM machine 20 driven by either of the servo controlled rack and pinion gear set 194, or the servo controlled hydraulic drive 196 of the incorporated '033 patent. Such optimal control can be obtained through programming controller 130 of the incorporated '033 patent for operation over a treatment session for a particular person including selected angular range and cyclical rate values in accordance with the following steps:

The first step 82 of the example method 80 is executed prior to initiating a VBPM therapy session for a person 30 on the bed 38 of a VBPM machine 20 and includes returning the bed 38 to its full upper torso and head-elevated position in order to provide a preferred entry/exit position of the bed 38. A second step 84 includes positioning the person 30 in a supine position upon the bed. A third step 86 includes either the person 30 or a therapist executing a “jog” command signifying that the person 30 has been properly placed on the bed 38, and enabling the program to continue. A fourth step 88 includes smoothly accelerating the bed 38 toward the horizontal position such that it reaches a maximum cyclical speed value concomitantly with reaching the horizontal position. A fifth step 90 includes executing a cyclical motion symmetrically about the horizontal position in accordance with the selected angular range and cyclical rate values for the duration of the VBPM therapy session.

While programming the controller 130 with a sinusoidal velocity profile for implementing the fifth step 90 certainly implements one preferred cyclical motion profile, others are possible. For instance, the modified cyclical motion of the crank and connecting rod mechanism 54 used in the preferred example VBPM machine 20 of the present invention results in a non-sinusoidal velocity profile having increased lowered dwell time for the upper torso 22 and head 24. If a similar modified cyclical motion is desired in a VBPM machine 20 driven by either of the servo controlled rack and pinion gear set 194, or the servo controlled hydraulic drive 196 of the incorporated '033 patent, it can easily be accommodated by programming the controller 130 with a velocity profile having both sinusoidal and even harmonics.

In any case, stopping the VBPM machine 20 in accordance with a sixth step 92 includes smoothly decelerating the bed 38 to zero speed at its preferred full upper torso and head-elevated entry/exit position, beginning with a final crossing of the bed 38 through the horizontal position as it moves toward the upper torso and head-elevated position. And finally, a seventh step 94 includes removing the person 30 from the bed 38 in order to terminate the VBPM therapy session. Given this description, one of ordinary skill in the art will recognize and be able to generate command sequences for obtaining suitable combinations of acceleration/deceleration characteristics, other treatment angular range and cyclical rate values, or varying values of angular ranges and cyclical rates during treatment sessions in order to meet the needs of particular persons.

Shown in FIG. 7 is a perspective view of the drive mechanism 52 with a cover 56 shown in FIG. 5 removed. In this example, the drive mechanism 52 includes a gearmotor 58 comprising a motor 60 and a speed-reducing gearbox 62 driving the afore-mentioned example crank and connecting rod drive mechanism 54. The crank and connecting rod drive mechanism 54 includes a crank 64 driven via an output shaft 66 of the speed-reducing gearbox 62. The crank 64 engages a connecting rod 68 that is pivotally connected to a drive arm 70 that extends from the bed 38. In this case the switch 36 is operative to activate and deactivate the motor 60 and thus the drive mechanism 52. It is true that the drive mechanism 52 is capable of only providing a single valued angular range. However, it does have the advantage of including readily available components such as the gearmotor 58 and switch 36. Therefore, it follows that a VBPM machine 20 comprising the example drive mechanism 52 can be quickly and economically developed, and may in fact, be more economical to produce. This could be important because it would be desirable to produce VBPM machines 20 in large volumes for home use by persons having various types of physical and neural diseases or conditions such as heart or other forms of cardiovascular disease, Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

Surprisingly, there is also an advantage in not utilizing a controller such as the controller 130 shown and described in the incorporated '033 patent. This is because such controllers typically utilize a bridge circuit comprising solid state switching devices that are usually relatively unshielded and therefore a source of high frequency electromagnetic radiation that is considered to be undesirable by a significant percentage of potential users of the example VBPM machine 20. In fact, such high frequency electromagnetic radiation could conceivably be dangerous for individuals using pacemakers. Thus, utilization of the drive mechanism 52 as controlled by the simple switch 36 in example VBPM machine 20 is considered herein to be preferable.

In the example drive mechanism 52 the gearmotor 58 serves to rotate the crank 64. Rotation of the crank 64 cyclically moves the connecting rod 68 back and forth along an undulating thrust axis “Y” in order to position and exert necessary forces on the drive arm 70 as required for it to cyclically move the bed 38 rotatably in a seesawing manner about the pivot axis “A”. The resulting cyclical motion of the bed 38 alternately elevates the upper torso and head, and then the lower extremities of a person lying on the bed 38 in the cyclical manner described hereinbefore. As described above, can be appreciated, the length of the crank 64 can either be designed for a larger or smaller stroke of the drive arm 70 and resulting angular range values, or even be configured in the manner of adjustable length crank arm 100 of the incorporated '033 patent in order to attain selected angular range values. Given these descriptions, one of ordinary skill in the art will recognize several variations in providing suitable drive mechanisms and drive modes for cyclically moving the bed 38.

Although preferred embodiments of this invention have been disclosed, workers of ordinary skill in the various arts associated with this invention would recognize that certain modifications would come within the scope of this invention. For instance, VBPM therapy could be utilized for treating other diseases or conditions not named above. Also, the construction details of the VBPM machine 20 could be altered without deviating from the spirit of this invention. By way of example, a modified bed 38′ could comprise independent torso and head, and lower extremity supporting portions capable of pivoting or rotating relative to each other. These could for instance, be utilized for altering the contoured shape of the bed 38. In another example, the speed-reducing gearbox 62 could be replaced by the combination of a hydraulic pump and hydraulic motor whose output shaft would then be utilized for driving the crank 64. For that reason, the following claims should be studied to determine the true scope and content of this invention.

What is claimed is:

1. A method for therapeutic treatment of a disease or ailment condition through the use of venous blood pressure modulation (VBPM) therapy, said method comprising the steps of:
providing a VBPM apparatus comprising:
a bed configured to retain a person thereupon in a supine manner generally along a longitudinal axis such that said person's upper torso and head are longitudinally spaced apart from said person's lower extremities;
said VBPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said VBPM apparatus further including a motor; and
a drive mechanism for selectively coupling said motor to said bed;
wherein said motor is energizable for rotatably and cyclically moving said bed about said pivot axis;
disposing a person on said bed so that said person lies supinely thereupon with his or her upper torso and head, and lower extremities spaced apart generally along said longitudinal axis; and
energizing said motor so as to activate said VBPM apparatus and thereby rotatably move said bed about said pivot axis through many cycles wherein said person's lower extremities are raised to a level higher than said person's upper torso and head, and vice-versa during each cycle;
wherein each cycle causes a modulation of the person's venous blood pressure wherein resulting multiple venous blood pressure modulation and/or switching events cause compression and stretching of the veins of the person's upper torso and head, and concomitantly, swelling and shrinking of the veins of the person's lower extremities, and
wherein said multiple venous blood pressure modulation and/or switching events result in cumulative internal massaging of arteries and fine arteries, neural fluid flow channels, and lymph fluid flow channels in the person's upper torso and head, and/or lower extremities.

2. The method as set forth in claim 1, wherein the angular range of motion of said longitudinal axis of said bed, and said person, about said pivot axis is between 10° and 60°.

3. The method as set forth in claim 2, wherein the selected angular range of motion of said longitudinal axis of between 10° and 60° extends symmetrically to either side of a nominally centered horizontal position.

4. The method as set forth in claim 2, wherein said longitudinal axis of said bed, and said person, are moved through an angular range of motion of about 30°.

5. The method as set forth in claim 4, wherein the selected angular range of motion of about 30° extends symmetrically to either side of a nominally centered horizontal position.

6. The method as set forth in claim 1, wherein the cyclical rate utilized for rotatably and cyclically moving said longitudinal axis of said bed, and said person, about said pivot axis is between 2 cycles/minute and 10 cycles/minute.

7. The method as set forth in claim 6, wherein the cyclical rate utilized for rotatably and cyclically moving said longitudinal axis of said bed, and said person, about said pivot axis is about 6 cycles/minute.

8. The method as set forth in claim 1, wherein the product of the angular range of motion of said longitudinal axis of said bed and the cyclical rate utilized for rotatably and cyclically moving said longitudinal axis of said bed is between 90 degree-cycles/minute and 270 degree-cycles/minute.

9. The method as set forth in claim 8, wherein the product of the angular range of motion of said longitudinal axis of said bed and the cyclical rate utilized for rotatably and cyclically moving said longitudinal axis of said bed is about 180 degree-cycles/minute.

10. The method as set forth in claim 1, further including said drive mechanism being selected from the group comprising a Scotch yoke mechanism, a crank and connecting rod mechanism, a linear drive mechanism, and a hydraulic drive mechanism.

11. The method as set forth in claim 10, wherein said drive mechanism includes said crank and connecting rod mechanism.

12. The method as set forth in claim 1, wherein said bed is configured such that when said longitudinal axis of said bed is disposed in a centered position, the torso and head supporting portion thereof is angled upwards with reference to said longitudinal axis at an angle approximately equal to half of the selected angular range while the thigh supporting portion thereof is oppositely angled upwards with reference to said longitudinal axis at an angle approximately equal to the selected angular range, and the calf and foot supporting portion thereof is disposed in a plane nominally parallel to said longitudinal axis.

13. The method as set forth in claim 1, wherein the disease or ailment condition is from among the group comprising heart or other forms of cardiovascular disease, Parkinson's disease, Alzheimer's disease, essential tremor, muscular dystrophy, autism, migraine headaches, traumatic brain injuries, varicose veins, fibromyalgia, drug addiction, and diabetes related problems such as high glucose count, impaired circulation, neuropathy, open wounds, and lymphedema with abnormal tissue swelling.

14. The method as set forth in claim 1, wherein the disease or ailment condition is heart disease, or other forms of cardiovascular disease.

15. The method as set forth in claim 1, wherein the disease or ailment condition is peripheral artery disease.

16. The method as set forth in claim 1, wherein the disease or ailment condition is Parkinson's disease.

17. The method as set forth in claim 1, wherein the disease or ailment condition is Alzheimer's disease.

18. The method as set forth in claim 1, wherein the disease or ailment condition is essential tremor.

19. The method as set forth in claim 1, wherein the disease or ailment condition is muscular dystrophy.

20. The method as set forth in claim 1, wherein the disease or ailment condition is autism.

21. The method as set forth in claim 1, wherein the disease or ailment condition is migraine headaches.

22. The method as set forth in claim 1, wherein the disease or ailment condition is traumatic brain injuries.

23. The method as set forth in claim 1, wherein the disease or ailment condition is varicose veins.

24. The method as set forth in claim 1, wherein the disease or ailment condition is fibromyalgia.

25. The method as set forth in claim 1, wherein the disease or ailment condition is drug addiction.

26. The method as set forth in claim 1, wherein the disease or ailment condition is from among the diabetes related group comprising high glucose count, impaired circulation, neuropathy, open wounds, and lymphedema with abnormal tissue swelling.

27. The method as set forth in claim 1, wherein the disease or ailment condition is high glucose count.

28. The method as set forth in claim 1, wherein the disease or ailment condition is impaired circulation.

29. The method as set forth in claim 1, wherein the disease or ailment condition is neuropathy.

30. The method as set forth in claim 1, wherein the disease or ailment condition is open wounds.

31. The method as set forth in claim 1, wherein the disease or ailment condition is lymphedema with abnormal tissue swelling.

32. The method as set forth in claim 1, wherein the method additionally comprises the steps of:
locating the VBPM apparatus in a relatively isolated and quite environment; and
maintaining a comfortable and relaxed state of the person.

33. The method as set forth in claim 32, wherein maintaining the comfortable and relaxed state of the person comprises avoiding any contact with the person (i.e., such as talking to him or her) with the purpose of inducing him or her into a state of sleeping.

34. The method as set forth in claim 32, wherein maintaining the comfortable and relaxed state of the person comprises engaging in quiet and relaxing conversation with a person for the purpose of calming him or her if he or she exhibits hyperactivity, hypersensitivity or hyperirritability symptoms.

35. The method as set forth in claim 32, wherein maintaining the comfortable and relaxed state of the person comprises choosing a combination of annular range and cyclical rate for rotatably and cyclically moving said bed about said pivot axis that precludes dizziness or other discomforts in the person.

36. The method as set forth in claim 35, wherein the combination of annular range and cyclical rate for rotatably and cyclically moving said bed about said pivot axis is between 90 degree-cycles/minute and 270 degree-cycles/minute.

37. The method as set forth in claim 36, wherein the combination of annular range and cyclical rate for rotatably and cyclically moving said bed about said pivot axis is about 180 degree-cycles/minute.

38. The method as set forth in claim 32, wherein the comfortable and relaxed state of the person is utilized for inducing persons suffering from sleep disorders to fall into a state of sleep when they experience insomnia.

39. The method as set forth in claim 38, wherein the state of sleep on a VBPM machine is maintained for extended time periods typically lasting well beyond an hour in length.

40. The method as set forth in claim 32, wherein VBPM therapy conducted oil a VBPM machine is specifically utilized for assisting persons in loosing weight.

41. A method for the treatment of a disease or ailment condition through the use of venous blood pressure modulation (VBPM) therapy, said method comprising the steps of:
providing a VBPM apparatus comprising:
a bed configured to retain a person thereupon in a supine manner generally along a longitudinal axis such that said person's upper torso and head are longitudinally spaced apart from said person's lower extremities;
said VBPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said VBPM apparatus further including a controller;
said VBPM apparatus further including a servomotor that is operatively connected to and driven by a power signal issued from said controller;
a drive mechanism for selectively coupling to said servomotor to said bed; and
said VBPM apparatus further including position measuring apparatus operatively connected to said bed and said controller, said position measuring apparatus issuing a position signal indicative of rotational positions of said longitudinal axis to said controller;
wherein said servomotor is energizable by said controller operating in a closed-loop manner via issuing a controlled power signal to said servomotor such that said position signal can be maintained in close conformance with a command signal representative of a selected program for rotatably and cyclically moving said bed about said pivot axis;
disposing a person on said bed so that said person lies supinely thereupon with his or her upper torso and head, and lower extremities spaced apart generally along said longitudinal axis; and
energizing said motor so as to activate said VBPM apparatus and thereby rotatably move said bed about said pivot axis through many cycles wherein said person's lower extremities are raised to a level higher than said person's upper torso and head, and vice-versa during each cycle;
wherein said each cycle causes a modulation of the person's venous blood pressure wherein resulting multiple venous blood pressure modulation and/or switching events cause compression and stretching of the veins of the person's upper torso and head, and concomitantly, swelling and shrinking of the veins of the person's lower extremities, and
wherein said multiple venous blood pressure modulation and/or switching events result in cumulative internal massaging of arteries and fine arteries, neural fluid flow channels, and lymph fluid flow channels in the person's upper torso and head, and/or lower extremities.

42. The method as set forth in claim 38, further including said drive mechanism being selected from the group comprising a linear drive mechanism and a hydraulic drive mechanism.

43. The method as set forth in claim 38, wherein said command signal is configured in accordance with the method additionally comprising the steps of:
prior to initiating a treatment session, returning said bed to its full upper torso and head-elevated position;
after the person has been positioned in a supine position upon the bed, executing a “jog” command signifying that said person has been properly placed on said bed;
smoothly accelerating said bed toward the horizontal position such that it reaches a maximum cyclical speed value concomitantly with reaching the horizontal position;
executing a cyclical motion symmetrically about said horizontal position in accordance with selected angular range and cyclical rate values for the duration of the treatment session;
smoothly decelerating said bed to zero speed at its full upper torso and head-elevated position, beginning with a final crossing of said bed through the horizontal position as it moves toward the upper torso and head-elevated position; and
removing said person from said bed in order to terminate said treatment session.

44. A method by which a bedridden patient would avoid his or her forming bed sores, said method comprising the steps of:
providing a VBPM machine enabled for cyclic operation at a low cyclic rate;
placing the bedridden person on the bed of the VBPM machine, and
activating it for cyclic motion.
